(19) United States
(12) Patent Application Publication
(10) Pub. No.: US 2008/0245977 A1
(43) Pub. Date: Oct. 9, 2008

(54) Radiopharmaceutical Dispenser Having Counter-Forced Access Mechanism and System and Method Therewith

(76) Inventors: Frank M. Fago, Mason, OH (US); Gary S. Wagner, Independence, KY (US)

Correspondence Address: Mallinckrodt Inc., 675 McDonnell Boulevard, HAZELWOOD, MO, 63042, US

(21) Appl. No.: 11/995,737

(22) PCT Filed: Jul. 26, 2006
(86) PCT No.: PCT/US2006/029058

§ 371 Date: Jan. 15, 2008

Related U.S. Application Data
(60) Provisional application No. 60/703,033, filed on Jul. 27, 2005.

(51) Int. Cl. H01J 5/18; G21F 5/00

(52) U.S. Cl. 250/505.1; 250/506.1

(57) ABSTRACT

The present invention generally relates to systems and methods for accessing a radiation shielded enclosure at least partially made of a radiation shielding material. For example, some systems of the invention include a radiation shielded receptacle configured to receive a radiopharmaceutical and a cover that is removably disposable across an opening into the receptacle. A counter-force mechanism may be biasingly coupled to the receptacle or the cover or a combination thereof. This counter-force mechanism may be said to exhibit a range of positions including a closed position, in which the cover is disposed across the opening, and an open position, in which the opening is uncovered.

### FIELD OF THE INVENTION

The invention relates generally to the field of nuclear medicine. Specifically, the invention relates to a system and method of accessing, dispensing, and/or extracting radioactive material from a container disposed within a radiation shield.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Nuclear medicine utilizes radioactive material for diagnostic and therapeutic purposes by injecting a patient with a small dose of the radioactive material, which concentrates in certain organs or biological regions of the patient. Radioactive materials typically used for nuclear medicine include Technetium-99m, Indium-113m, and Strontium-87m among others. Some radioactive materials naturally concentrate toward a particular tissue, for example, iodine concentrates toward the thyroid. However, radioactive materials are often combined with a tagging or organ-seeking agent, which targets the radioactive material for the desired organ or biologic region of the patient. These radioactive materials alone or in combination with a tagging agent are typically defined as radiopharmaceuticals in the field of nuclear medicine. At relatively lower doses of the radiopharmaceutical, a radiation imaging system (e.g., a gamma camera) may be utilized to provide an image of the organ or biological region on or in which the radiopharmaceutical binds or deposits. Irregularities in the image are often indicative of a pathologic condition, such as cancer. Higher doses of the radiopharmaceutical may be used to deliver a therapeutic dose of radiation directly to the pathologic tissue, such as cancer cells.

Safety is an important concern in the practice of nuclear medicine. A variety of radiation shielding systems are used while generating radioisotopes, combining the radioisotopes with a tagging agent, dispensing radiopharmaceuticals into syringes, and injecting the radiopharmaceuticals from the syringes into patients. These radiation shielding systems are intended to minimize radiation exposure by those preparing, transporting, injecting, and receiving doses of the radioactive materials. Unfortunately, radiation shielding materials by nature tend to be heavy, and existing shielding systems often involve manual handling of bulky containers, lids, syringes, and vials. The weight and ergonomic configuration can lead to repetitive motion stress for the operator. The manual handling of these bulky shielding systems opens the possibility for improper or misaligned connections of syringes with dispensers, accidentally uncovered containers, spills, and other human errors than can result in nonproductive radiation exposure.

### SUMMARY

The present invention, in certain embodiments, relates to a system and method for accessing a radiation shielded enclosure (e.g., elution shield or dispensing shield) made of, or at least including, a radiation shielding material. Some aspects of the invention include a radiation shielded enclosure and a counter-force mechanism. The radiation shielded enclosure of some embodiments may include a receptacle configured to receive a radiopharmaceutical, and a cover that may be removably disposed across an opening into the receptacle. The counter-force mechanism may be biasingly coupled to one or more of the receptacle or the cover. The counter-force mechanism of some embodiments may exhibit a range of positionability. For instance, in some embodiments, the cover may be disposed across the opening of the receptacle when the counter-force mechanism is in a closed position. Likewise, the cover may be dissociated from the opening in the receptacle (e.g., the opening may be uncovered) when the counter-force mechanism is in an open position.

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with a first aspect of the present invention, there is provided a radiopharmaceutical system. The system includes a radiopharmaceutical receptacle composed of a first radiation shielding material. The system further includes a cover composed of a second radiation shielding material (that may be the same as or different from the first radiation shielding material) and removably disposable across an opening into the radiopharmaceutical receptacle, and a counter-force mechanism biasingly coupled to the radiopharmaceutical receptacle, or the cover, or a combination thereof. Incidentally, “biasingly coupled” or the like herein refers to a coupling of two or more of structures that, due to the nature of the coupling, is characterized by at least one of the structures being urged/biased in a direction relative to (e.g., toward or away from) another(others) of the structure(s). The counter-force mechanism exhibits a range of positionability including a closed position wherein the cover is disposed across the opening and an open position wherein the opening is uncovered.

In accordance with a second aspect of the present invention, there is provided a radiopharmaceutical dispenser. The radiopharmaceutical dispenser includes a radiopharmaceutical receptacle comprising a first radiation shielding material, a cover comprising a second radiation shielding material and removably disposable across an opening into the radiopharmaceutical receptacle, and a biasing mechanism imposing a biasing force on the radiopharmaceutical receptacle, or the cover, or a combination thereof. Further, the radiopharmaceutical dispenser includes a movable member having a first portion coupled to the biasing mechanism and a second portion coupled to the radiopharmaceutical receptacle, or the cover, or a combination thereof. A distance between the radiopharmaceutical receptacle and the cover is a first distance when the movable member is in a first position, and the distance between the radiopharmaceutical receptacle and the radiopharmaceutical cover is a second distance greater than the first distance when the movable member is in a second position different from the first position.

In accordance with a third aspect of the present invention, there is provided a method of using a radiopharmaceutical dispenser. The method includes imposing a first force in a first direction on a first component of a radiopharmaceutical dispenser. The first force is supplemented with a second force having a vector component substantially aligned with the first direction. The imposition of the first force is insufficient to move the first component relative to a second component of the radiopharmaceutical dispenser. However, the supplementation of first force with the second force is sufficient to move the first component relative to the second component. Incidentally, the first and/or second components may include one or more appropriate radiation shielding materials. It should further be noted that the first and second components cooperate to contain a radiopharmaceutical.

In accordance with a fourth aspect of the present invention, a radiopharmaceutical container is supported on a base, wherein the radiopharmaceutical container comprises a first radiation shielding material. A radiopharmaceutical cover is movably supported along a path of travel between a first position at which the radiopharmaceutical cover extends across an opening in the radiopharmaceutical container and a second position at which the radiopharmaceutical cover is offset from the opening of the radiopharmaceutical container, wherein the radiopharmaceutical cover comprises a second radiation shielding material. The radiopharmaceutical cover tends to be biased toward the first position.

Various refinements exist of the features noted above in relation to the various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### BRIEF DESCRIPTION OF THE FIGURES

Various features, aspects, and advantages of some exemplary embodiments of the present invention will become better understood when the following detailed description is read with reference to the accompanying figures in which like characters represent like parts throughout the figures, wherein:

FIG. 1 is a side view of an exemplary system having a radiation shielding device coupled to a hoist;

FIG. 2 is side view of the radiation shielding device coupled to the hoist of FIG. 1, further illustrating the shielding device in a raised position to receive a syringe;

FIG. 3 is a side view of the radiation shielding device coupled to the hoist of FIG. 2, further illustrating a locking mechanism;

FIG. 4 is a side view of the radiation shielding device coupled to the hoist of FIG. 3, further illustrating the shielding device in a raised and tilted position to facilitate a connection between the syringe and the radiation shielding device;

FIG. 5 is an exploded side view of the hoist exploded from an alternative embodiment of the radiation shielding device illustrating a cable of the hoist being lowered toward a connection ring disposed on a top portion of the shielding device away from a central axis and center of mass of the shielding device;

FIG. 6 is a side view of the hoist coupled to the radiation shielding device of FIG. 5, further illustrating the shielding device in a partially raised position, wherein the off-center location of the connection ring causes the shielding device to tend towards an angled position;

FIG. 7 is a side view of the hoist coupled to the radiation shielding device of FIG. 6, further illustrating the radiation shielding device in a raised and tilted position to facilitate a connection between the syringe and the radiation shielding device;

FIG. 8 is a side view of the hoist coupled to the radiation shielding device of FIG. 7, further illustrating a locking mechanism to secure the hoist and shielding device in the raised position;

FIG. 9 is an exploded side view of the hoist exploded from another embodiment of the radiation shielding device, illustrating a connection ring disposed on a side portion of the shielding device away from the central axis and center of mass of the shielding device;

FIG. 10 is a side view of the hoist coupled to the radiation shielding device of FIG. 9, further illustrating the radiation shielding device in a raised and tilted position to facilitate a connection between the syringe and the radiation shielding device;

FIG. 11 is an exploded side view of a sheath adapted to couple to the shielding device, wherein the sheath includes a connection ring for coupling to the hoist at a position away from the central axis (and center of mass) of the shielding device;

FIG. 12 is a perspective view of an exemplary leverage tool holding the shielding device;

FIG. 13 is a side view of the leverage tool holding the shielding device of FIG. 12, further illustrating a lift assist mechanism powered by a counter-spring;

FIG. 14 is a side view of the leverage tool holding the shielding device of FIG. 12, further illustrating a lift assist mechanism powered by a counter-weight;

FIG. 15 is a side view of the leverage tool holding the shielding device of FIG. 12, further illustrating a lift assist mechanism and a foot operated trigger;

FIG. 16 is a perspective view illustrating an exemplary dispensing stand holding the shielding device in a closed position;

FIG. 17 is a side view of the dispensing stand holding the shielding device of FIG. 16;

FIG. 18 is a side view of the dispensing stand of FIG. 16 holding the shielding device in an open position, and further illustrating a syringe guide holding a syringe in a direction aligned with and inserted into an opening in the shielding device;

FIG. 19 is a side view of the dispensing stand holding the shielding device and a syringe of FIG. 18, further illustrating an upper guide disposed about the syringe opposite from the syringe guide;

FIG. 20 is a flow chart illustrating an exemplary nuclear medicine process utilizing a dispensing system of FIGS. 1-19;

FIG. 21 is a block diagram illustrating an exemplary system for producing a container, such as a syringe, of a radiopharmaceutical obtained using a dispensing system of FIGS. 1-19; and

FIG. 22 is a block diagram illustrating an exemplary nuclear medicine imaging system utilizing the syringe of the radiopharmaceutical of FIG. 21.

### DETAILED DESCRIPTION OF ILLUSTRATED EMBODIMENTS

One or more exemplary embodiments of the present invention are described below. In an effort to provide a concise description of these embodiments, some features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Such a development effort would be a routine undertaking of design, fabrication, and manufacture for those of ordinary skill having the benefit of this disclosure.

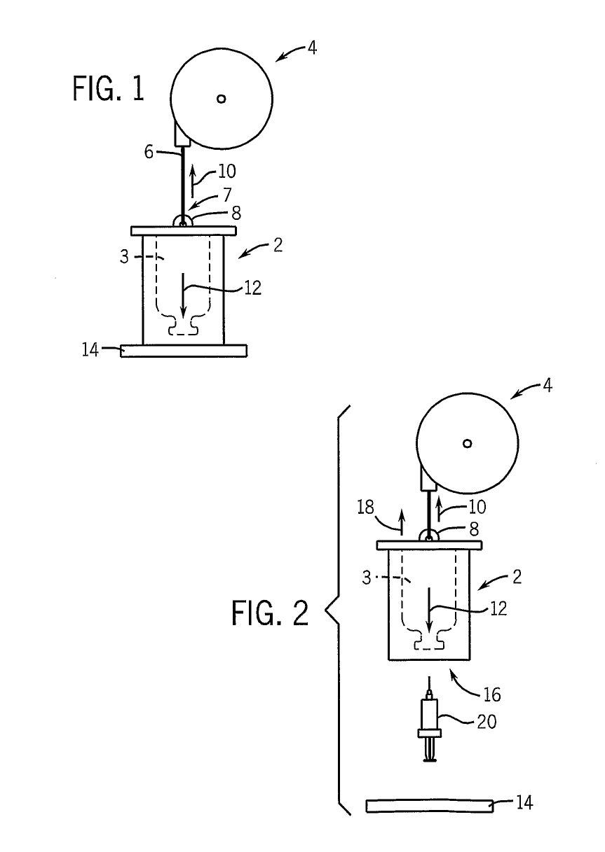

The embodiments discussed in detail below relate to a system and method for assisting a user in extracting radioactive material (e.g., a radioisotope) from a vial within a radiation shielding device (e.g., an elution shield or dispensing shield). For example, FIG. 1 shows an exemplary lift-assisted dispensing system including a radiation shielding device 2 (e.g., a radiation shielded receptacle) housing a vial 3 and coupled to a counter-force device (e.g., a tool balancer). Incidentally, “coupled” or the like herein generally refers to two or more components that are either directly or indirectly connected to one another. In the embodiment illustrated in FIG. 1, the counter-force device is a hoist 4, which includes a retractable cord 6 with an attachable end 7 (e.g., end that is attached to or at least attachable to the radiation shielding device 2) and a range of positionability (e.g., can be extended and retracted as desired). The cord 6 extends from the hoist 4 and attaches to a connection ring 8 coupled directly to the shielding device 2. The connection ring 8 may be any appropriate connection device. For instance, the connection ring 8 can be rigid or it can be adapted to rotate from a flush position against the shielding device 2 into a position allowing for its connection to the cord 6 (e.g., via an eye hook). The cord 6 may be wound about a spring powered reel (not shown) within the hoist 4 such that it retracts into the hoist 4 with a certain amount of lifting or tension force, as illustrated by arrow 10. In the illustrated embodiment, the force 10 imparted by the hoist 4 on the shielding device 2 via the cord 6 is no more than (e.g., less than or substantially equal to) the weight of the shielding device 2, as illustrated by arrow 12 at the center of mass. Because the force 10 is less than or equal to the weight 12, the shielding device 2 remains in place atop a radiation shielding cover 14 unless external force is applied in combination with the force 10 to counter and exceed the weight force 12. In view of this lifting force or tension 10, the user can more easily raise and handle the shielding device 2, thereby facilitating access to the vial 3. It should be noted that while FIG. 1 illustrates the counter-force device as the hoist 4, other embodiments of the counter-force device may include an electric motor, a gear mechanism, a hydraulic mechanism, a pneumatic mechanism, a leveraging mechanism, and/or any other appropriate mechanism. Further, while the force imparted by the hoist 4 on the shielding device 2 has been described as being no more than the weight 12 of the shielding device 2 in the illustrated embodiment, it should be noted that some embodiments include hoists that impart magnitudes of force that may be greater than the weight 12 of the shielding device 2.

The radiation shielding device 2 and a radiation shielding cover 14, which may be referred to herein simply as the shielding device 2 and the shielding cover 14, typically include appropriate radiation shielding material (e.g., lead, tungsten, and/or tungsten impregnated plastic) that reflects and/or absorbs radiation. The shielding device 2 may be made of a first shielding material, and the shielding cover 14 may be made of a second shielding material. In some embodiments, the first and second materials are the same material, and in other embodiments the first and second shielding materials are different materials. Shielding devices of the invention may be any appropriate shape and size. For instance, the shielding device 2 typically weighs from three to five pounds and may, at least in some embodiments, be referred to as an elution shield and/or a dispensing shield. The term “elution shield” generally refers to a radiation shielding device that may be utilized when extracting (or eluting) a radioisotope from a radioisotope generator. The term “radioisotope generator” typically refers to a radiation shielded container that holds a parent radioisotope, such as Molybdenum-99 absorbed to alumina beads or another suitable exchange medium, and is capable of providing a daughter radioisotope (from the parent radioisotope), typically in the form of a solution. An exemplary elution shield is generally adapted to hold an evacuated collection bottle (e.g., vial 3) that can receive the daughter radioisotope from the radioisotope generator. With regard to an exemplary generator, a bottle containing eluant (e.g., sterile saline) is generally attached to an inlet of the radioisotope generator, such that the eluant can circulate through the radioisotope generator to the evacuated collection bottle (e.g., vial 3). The daughter radioisotope (e.g., technetium-99M) is held chemically less tightly than the parent, thereby enabling the eluant to flush the daughter radioisotope from the radioisotope generator into the collection bottle.

Once collected, radioisotopes are often combined with specialized chemicals to produce various types of radiopharmaceuticals. For example, many radiopharmaceuticals are produced by combining radioisotopes with chemicals referred to as tagging (or targeting) agents. A tagging agent generally refers to a pharmacologic agent that is predominantly taken up by and/or binds to a certain part of the body (e.g., receptors of a particular cell or tissue type) and that facilitates imaging and/or treatment of that part of the body. Radiopharmaceuticals are used for many medical procedures where they are administered into bodies of patients. For instance, doses of radiopharmaceuticals are frequently injected into patients using syringes. These syringes may be filled by a radiopharmacist who prepares or acquires the doses one at a time (referred to in the art as “unit doses”). Because radiopharmaceuticals are radioactive, it is desirable to limit radiation exposure to users (e.g., radiopharmacists that are preparing and/or dispensing the doses). Thus, a dispensing shield is typically used during dispensing procedures. The term “dispensing shield” generally refers to a radiation shielding device that holds or contains a vial of radioisotope solution for protecting a technician when drawing a radioisotope solution or radiopharmaceutical from the vial into a syringe. A dispensing shield may be said to be at least generally similar to an elution shield. For example, like an elution shield, a dispensing shield includes radiation shielding material and is adapted to hold a vial (e.g., during transfers of radioactive material). Further, like an elution shield, a dispensing generally shield protects users from overexposure to radiation when dispensing the radioactive material contained in the vial. Dispensing shields are typically utilized in situations where radioactive material is repeatedly being withdrawn. For example, a radiopharmacist may extract a number (e.g., tens or even hundreds) of doses of radiopharmaceutical per day from a vial disposed within a dispensing shield.

FIG. 2 is an exploded side view of the radiation shielding device 2 coupled to the hoist 4, wherein the shielding device 2 is in a raised position assisted by the hoist 4. Access to the radiopharmaceutical stored within the shielding device 2 is provided through an opening 16 in the shielding device 2 that may be covered by the shielding cover 14. A user can access a radiopharmaceutical inside the vial 3 (which is disposed in the shielding device 2) by moving at least one of the shielding device 2 and the shielding cover 14 away from the other. It should be noted that the phrase “at least one of A and B” is intended to mean A, or B, or combinations thereof in context of the present disclosure and claims. For example, as illustrated in FIG. 2, a user may lift the shielding device containing the vial 3 of radiopharmaceutical by applying a supplemental force 18 (which may be less than the weight 12 of the shielding device 2) to the shielding device 2. The supplemental force 18 may be combined with the force 10 being exerted by the hoist 4 to lift the shielding device 2. Because the hoist 4 is already exerting an upward force 10, the user may not be required to exert as much force as would otherwise be necessary to access the opening 16. This may be beneficial for a number of reasons (e.g., safety and efficiency). For example, when a large number of extractions need to be made, the reduced force required to expose the vial 3 inside the shielding device 2 may be beneficial because it may reduce potential for repetitive use injuries. It should be noted that the supplemental force 18 can be imparted in any appropriate manner (e.g., manually, electronically, mechanically, and/or the like). For instance, the supplemental force 18 may be imparted by simply grasping the shielding device 2 (e.g., with the users hand) and moving the shielding device 2 toward the hoist 4.

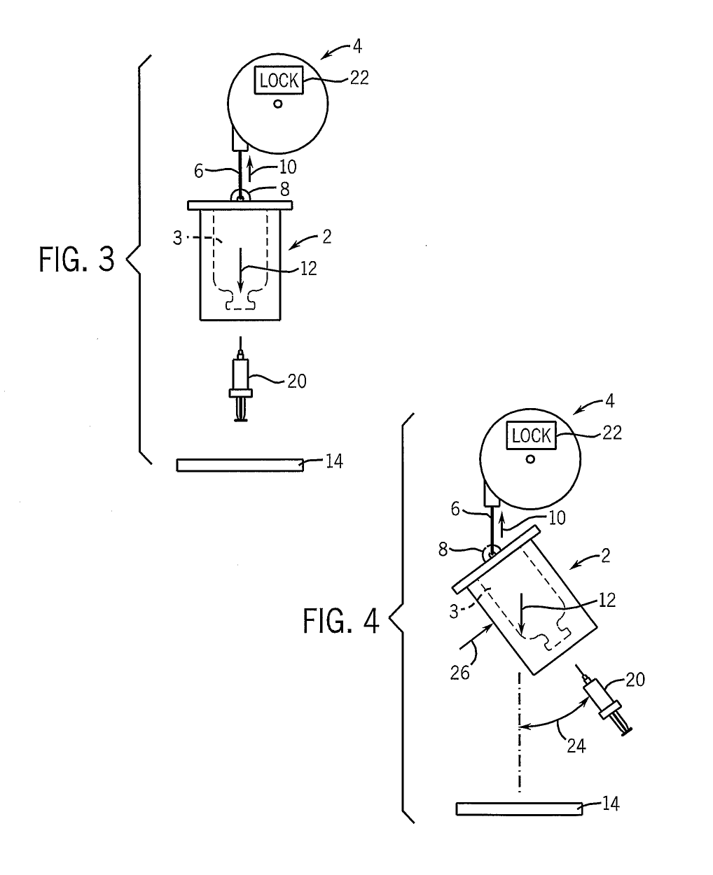

Once the shielding device 2 is moved away from the shielding cover 14 and the opening 16 is accessible, the user may insert a hollow needle of a syringe 20 through the opening 16 in the dispensing shield 2, and draw a dose of the radiopharmaceutical into the syringe 20. While withdrawing the dose from the vial 3, the user of some embodiments can either continue lifting the dispensing shield 2 by applying the force 18 or the user can lock the cord 6 into position using a lock 22 within the hoist 4, as illustrated in FIG. 3. By locking the shielding device 2 into a raised position, some users may believe the radiopharmaceutical is more easily and/or accurately extracted from the vial 3 into the syringe 20. One characterization of the locked orientation may be to say that force 10 counterbalances the gravitational force 12, which frees a user from exerting the supplemental force 18. As illustrated by FIG. 4, access to the radiopharmaceutical may be further facilitated by tilting the shielding device 2 at an angle 24 by applying a force 26. Upon acquiring the dose and after disengaging the lock 22, the shielding device 2 may be replaced on top of the shielding cover 14. Throughout this extraction procedure, the shielding device 2 preferably reflects and/or absorbs radiation from the radiopharmaceutical and thus reduces the potential for exposing a user to radiation.

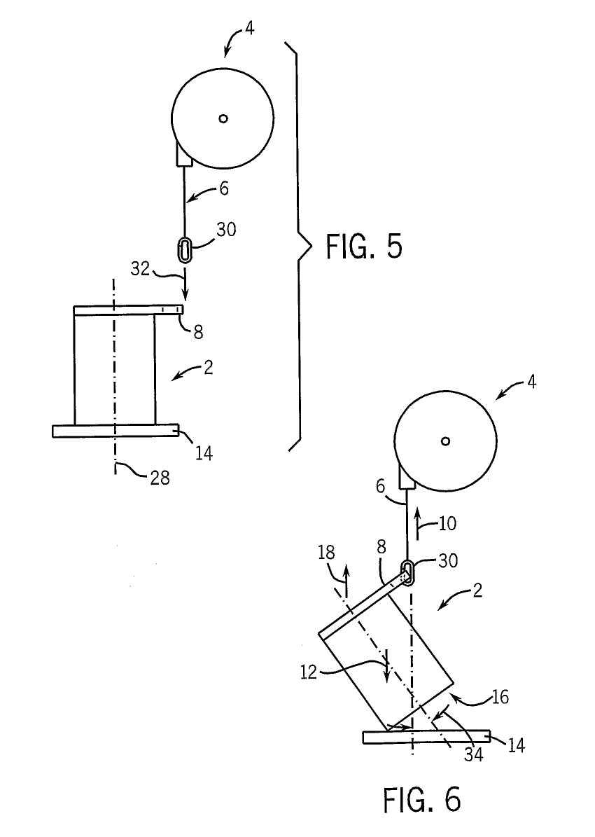

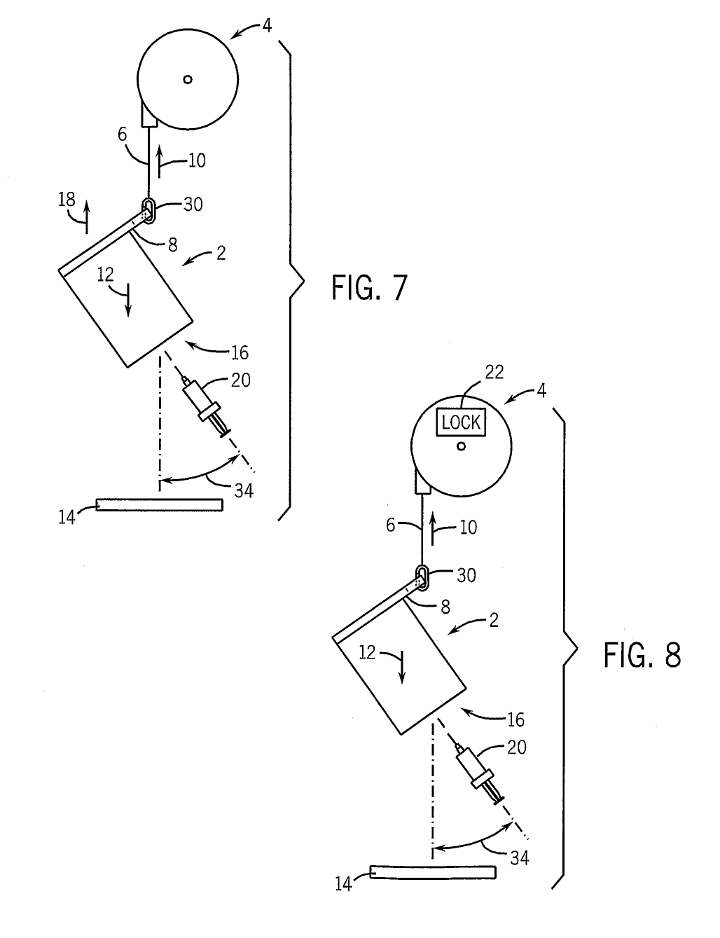

FIG. 5 shows an alternative embodiment, wherein the connection ring 8 (e.g., a D-ring) is located on a top portion of the shielding device 2 and away from the central axis 28 of the shielding device 2. As illustrated in FIG. 5, the cord 6, having any eye hook 30, is being extracted (e.g., let out) from the hoist 4 (as illustrated by arrow 32) to attach the eye hook 30 to the connection ring 8. Once connected, the hoist 4 may exert lifting force 10 on the shielding device 2 via the off-centered connection ring 8. This generally results in the force 10 tending to be exerted away from the central axis 28 (and center of mass) of the shielding device 2. Accordingly, when a user exerts the supplemental force 18 in addition to the force 10, the shielding device 2 tends toward a position having an angle 34 with respect to vertical, as illustrated in FIG. 6. This angled position can facilitate access for the syringe 20, when extracting radiopharmaceuticals, as illustrated in FIG. 7. Further, as illustrated in FIG. 8, the lock 22 can be utilized to assist in holding the shielding device 2 at the angle 34 to further facilitate access by the syringe 20.

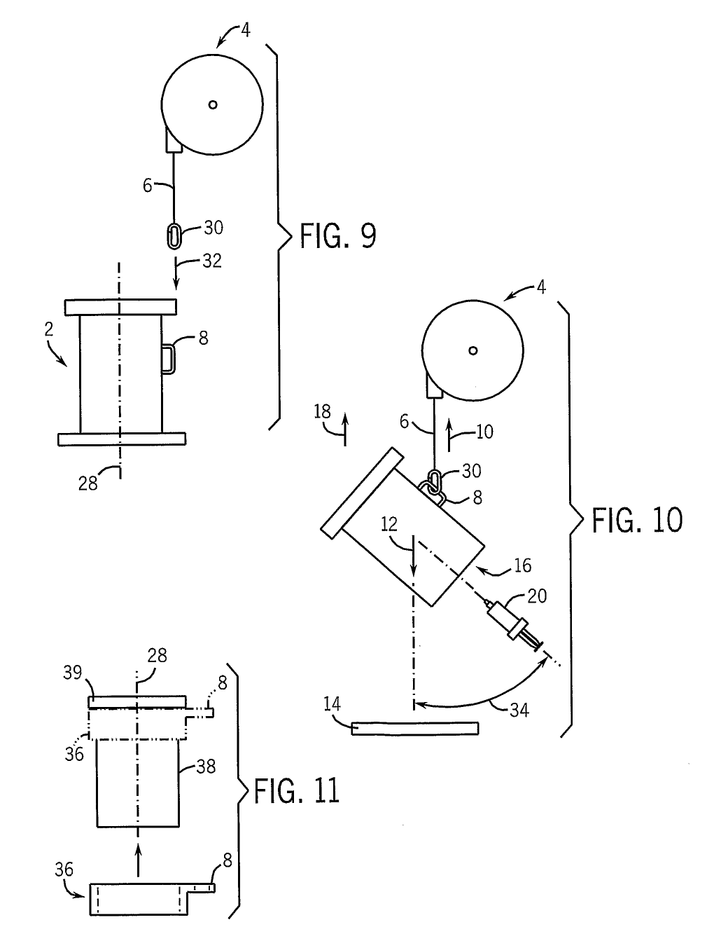

FIG. 9 shows another alternative embodiment, wherein the connection ring 8 (e.g., a D-ring) is located on a side portion of the shielding device 2 and away from the central axis 28 (and center of mass) of the shielding device 2. As illustrated in FIG. 9, the cord 6, having the eye hook 30, may be extracted from the hoist 4 (as illustrated by arrow 32) to attach the eye hook 30 to the connection ring 8. Once connected, the hoist 4 may exert lifting force 10 on the shielding device 2 via the off-centered connection ring 8. Again, the force 10 tends to be exerted away from the central axis (and center of mass) of the shielding device 2. Accordingly, when a user exerts the supplemental force 18 in addition to the force 10, the shielding device 2 tends toward a position having an angle 34 relative to vertical, as illustrated in FIG. 10. The illustrated configuration of the connection ring 8 on the side of the shielding device 2 serves to further increase the angle 34 as compared to lifting along the axis 28. Indeed, it should be noted that the position of the connection ring 8 can be adjusted to various positions with respect to the axis 28 (and center of mass) to predispose the shielding device 2 toward certain angled positions that facilitate access for the syringe 20.

FIG. 11 shows yet another alternative embodiment, wherein the connection ring 8 is a component of a removable sleeve or sheath 36. The sheath 36 is particularly useful for retrofitting an existing shielding device 2 for use with the hoist 4. In the illustrated embodiment, the sheath 36 couples to the shielding device 2 by sliding over a base portion 38 of the shielding device 2 and interfacing with a lip 39 of the shielding device 2. The hoist 4 is coupled to the connection ring 8 of the sheath 36 and imparts an upward force 10 to the shielding device 2 via the sheath 36. In accordance with the illustrated embodiment, a user can remove the sheath 36 by sliding it downwardly along and then apart from the based portion 38. In other embodiments, different mechanisms are used to couple the sheath 36 to the shielding device 2. For example, the sheath 36 can be clamped around the shielding device 2 or attached by a threaded fastener. Other embodiments include other appropriate designs for the sheath 36; accordingly, the scope of the present invention includes all devices that may be coupled with a shielding device 2 to enable a force 10 to be imposed on the shielding device 2. On another note, while the illustrated embodiment shows a connection ring 8 that is located near the top of the shielding device 2 and away from its central axis 28, other embodiments of the sheath 36 can exhibit other appropriate locations of the connection ring 8 with respect to the shielding device 2. For example, each of the embodiments illustrated by FIGS. 1-10 could employee the sheath 36 to provide the connection ring 8 in a desired orientation.

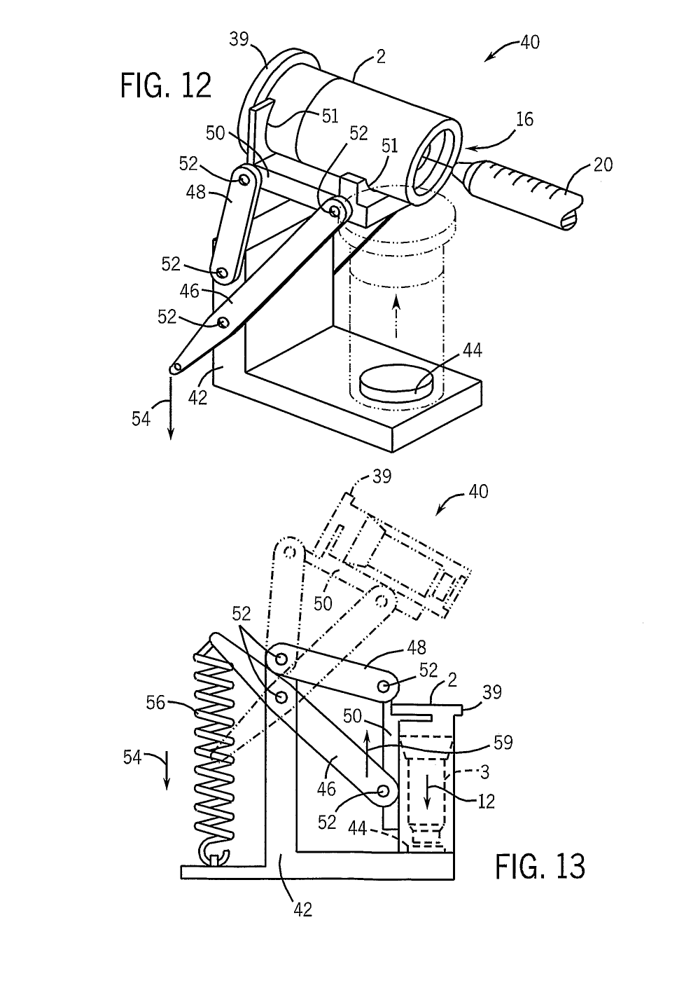

FIG. 12 shows a leverage tool 40 that may be characterized as a lift-assisted dispensing system. The leverage tool 40 is a counter-force device adapted to aid in the lifting and positioning of the shielding device 2 and, thus, to facilitate extraction of radioactive material through the opening 16 using the syringe 20. Specifically, the leverage tool 40 includes a base 42, a cover or cap 44, a lever 46, a stabilizing arm 48, and a container support 50. The illustrated base 42 and cap 44 are composed of (or at least include) radiation shielding material to reduce the potential for exposing users to radiation when the leverage tool 40 is holding the shielding device 2 in a closed position (dashed lines) with radioactive material disposed therein. The container support 50 is configured to receive, support, and removably couple with the shielding device 2. As illustrated, the container support 50 includes a pair of opposite semi-cylindrical receptacles 51, which are shaped and sized to fit closely about the cylindrical exterior of the shielding device 2. Moreover, the upper lip 39 rests against the container support 50 adjacent one of the receptacles 51. The stabilizing arm 48 cooperates with the lever 46 to rotate the container support 50 (and shielding device 2) about a curved path of travel between the closed position (dashed lines) and the illustrated raised and open position of the shielding device 2. In operation, the lever 46 and stabilizing arm 48 rotate about pivot joints 52 disposed on the base 42 and container support 50 within a range of positionability (e.g. including a closed position, an open position, and positions in between). When a sufficient force is applied to the layer 46, as illustrated by arrow 54, the leverage tool 40 raises the support 50 (and the attached shielding device 2) away from the lowered/closed position (dashed lines) toward the illustrated open/raised position away from the cap 44. This may enable a user to rapidly and/or easily withdraw radioactive material from within the shielding device 2 using a syringe 20. The leverage tool 40 may tend to reduce the requisite manual force for moving the shielding device 2, while also positioning the shielding device 2 and the opening 16 at a desired orientation, such as a generally horizontal angle (or closer to a horizontal angle) to facilitate visualization, centering, and connection of the syringe 20 and vial 3. In the embodiments shown in FIGS. 12-13, the shielding device 2 travels a substantially arcuate path between the open and closed positions. Accordingly, while the various forces are illustrated as arrows having straight lines, arcuately directed forces (as well as forces of other orientations) may be appropriate employed as well.

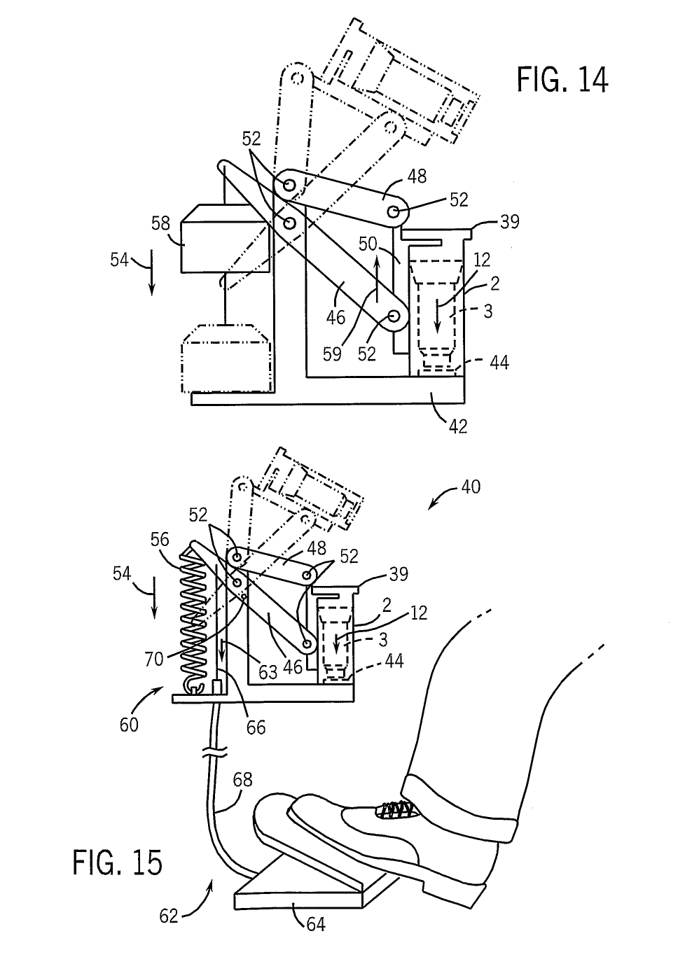

When utilizing the leverage tool 40, the force 54 to lift the shielding device 2 can be imparted by various different mechanisms. For example, a user can simply press down on the end of the lever 46 with a hand to impart the force 54 necessary to raise the shielding device 2. However, as discussed above, some shielding devices 2 tend to be made of heavy material, and users may benefit when the manual force in lifting the shielding device 2 is reduced. For example, users may avoid repetitive use injuries, avoid accidents, and/or perform more consistently by limiting the amount of force required of the user to lift the shielding device 2 during extraction procedures. Accordingly, in some embodiments, the leverage tool 40 may include a lift assist mechanism. For example, FIG. 13 illustrates a spring 56 coupled to the leverage tool 40 between the lever 46 and the base 42, thereby providing the force 54 on the lever 46 to at least partially oppose the weight 12 of the shielding device 2. Similarly, FIG. 14 illustrates a counter-force weight 58 coupled to the outer end of the lever 46, thereby providing the force 54 on the lever 46 to at least partially oppose the weight 12 of the shielding device 2. In this maimer, the spring 56 and weight 58 both operate as lift assist mechanisms. Indeed, in the illustrated embodiments, the leveraging tool 40 assisted by the spring 56 and weight 58 collectively provide a counter-force 59 that may be no more than (e.g., less than or equal to) the weight 12 of the shielding device 2. For example, if the shielding device 2 weighs five pounds, the spring 56 or the weight 58 may be calibrated such that the force 59 may be less than or equal to five pounds exerted on the shielding device 2 in a direction generally away from the cap 44. This may tend to allow a user to relatively easily raise the shielding device 2 to gain access to the opening 16 and vial 3 by providing supplemental force in cooperation with the lift assist mechanism.

FIG. 15 shows the leverage tool 40 including a lift assist mechanism 60 and a foot operated trigger (e.g., foot pedal) 62 for substantially hands-free operation. In the illustrated embodiment, the lift assist mechanism 60 is a spring 56 that imparts a biasing force 54 on the shielding device 2 towards an open position away from the cap 44. However, the biasing force 54 may not be sufficient (in and of itself) to lift the weight 12 of the shielding device 2 without the imposition of a supplemental force. Accordingly, the foot operated trigger 62 may be configured to supply a supplemental force 63 that may be combined with the spring biasing force 54 to raise the shielding device 2 into an accessible raised position (dashed lines). Any and all designs for a foot operated trigger that can be used to provide a supplemental force are within the scope of the present invention. Further, while the foot operated trigger 62 is shown as a component of the leverage tool 40, any of the aspects and embodiments of the present invention may include an appropriate foot operated trigger. With regard to the illustrated embodiment, the foot operated trigger 62 includes a foot pedal 64 that attaches to a cable 66 extending movably through a tube 68. When the pedal 64 is actuated (e.g., depressed), it pulls or retracts the cable 66 inwardly through the tube 68 towards the foot pedal 64. At an opposite end from the foot pedal 64, the cable 66 may be coupled to the lever 46 (and/or other appropriate portion of the leverage tool 40) and, thus, the cable 66 imposes the downward force 63 on the lever 46 when the foot pedal 64 is depressed. This force 63, in addition to the force 54 being imparted by the lift assist mechanism 60, generally causes the leverage tool 40 to raise the shielding device 2 into an open raised position. It should be noted that, in some embodiments, the leverage tool 40 includes a locking mechanism 70 (e.g., a spring operated latch) that may be engaged (manually and/or automatically) when the shielding device 2 reaches a certain position. The locking mechanism 70 may hold the shielding device 2 in place until disengaged by the user. For example, the locking mechanism 70 of some embodiments may hold the shielding device 2 in a closed lowered position to reduce potential for exposure to radioactive material contained therein and/or it may hold the shielding device 2 in an accessible raised position to facilitate withdrawal of radioactive material from within the shielding device 2.

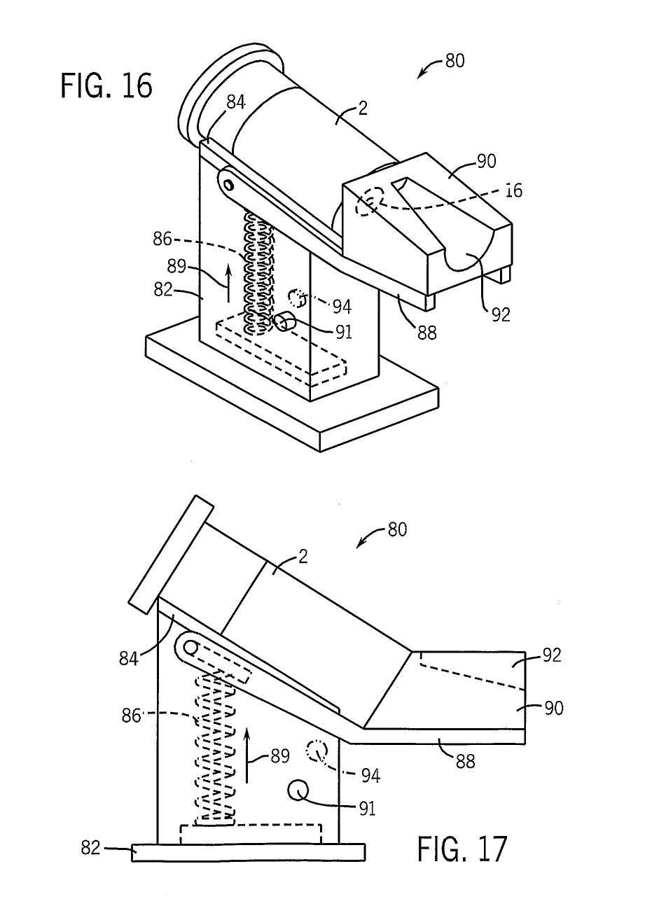

FIG. 16 is a perspective view illustrating an exemplary embodiment of a counter-force radiopharmaceutical dispenser or lift-assisted dispensing stand 80. The illustrated dispensing stand 80 holds the shielding device 2 in position at a comfortable working height and at an angle conducive for dispensing radioactive material from the vial 3 through the opening 16. Any and all heights and orientations for holding the shielding device 2 are included in the scope of the present invention, including, but not limited to, a variety of generally upward orientations, generally downward orientations, and generally horizontal orientations. The dispensing stand 80 includes a base 82, a container support 84, a spring biasing device 86, a rotatable arm 88, and a cover/syringe guide 90. In the illustrated embodiment, the arm 88 is pivotally interconnected to the base 82 on one end and is coupled to the syringe guide 90 at the other end. Incidentally, a “pivotal interconnection” or the like, generally refers to any type of interconnection that allows a structure to at least generally undergo a pivoting or pivotal-like motion when exposed to an appropriate force, including without limitation any interconnection that allows a structure or a portion thereof to move (e.g., rotate) at least generally about a certain axis. In addition to axial rotation, representative pivotal interconnections also include the use of a flexing or elastic deformation of a structure or a portion thereof, as well as the use of relative motion between two or more structures that are typically in interfacing relation during at least a portion of the relative movement (e.g., a hinge connection and/or a ball and socket connection). The arm 88 has a range of positionability (e.g., along a substantially arcuate path) including an open position, a closed position, and positions in between. The spring 86 upwardly biases the arm 88 and effectuates force 89, such that the arm 88 is predisposed to rotating upward toward the container support causing the syringe guide 90 to block the opening 16 in the shielding device 2. In the closed position shown in FIG. 17, the syringe guide 90, which includes an appropriate radiation shielding material, reduces the potential for exposure of users to radioactive material contained in the shielding device 2. It should be noted that while the illustrated embodiment employs the spring 86 to operate arm 88, in other embodiments, different mechanisms (e.g., a detent mechanism, lever, and/or other appropriate force-providing mechanism) may be used to impose the desired force 89 on the arm 88. For example, the spring 86 can be replaced or supplemented with hydraulics, pneumatics, a leverage mechanism, a motorized drive, and so forth.

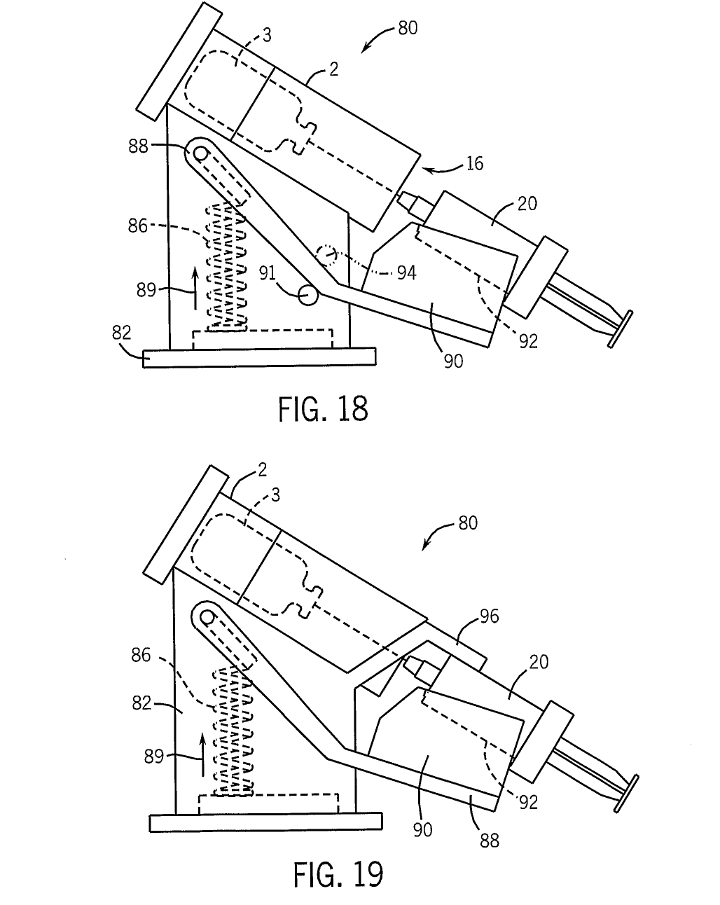

In order to access the opening 16 and retrieve a dose of radiopharmaceutical from a vial within the shielding device 2 using the syringe 20, a user may compress the spring 86 by pushing the syringe guide 90 at least generally downward into an open position (e.g., against a stop 91), as illustrated by FIG. 18. In this open position, the syringe guide 90 may be utilized to facilitate controlled alignment and insertion of the syringe 20 (e.g., a hollow needle thereof) into the vial inside the shielding device 2. For example, in the embodiment of FIG. 18, the syringe guide 90 includes a groove or channel 92 shaped and dimensioned to accommodate (e.g., closely fit with) the shape and dimensions of the syringe 20. Accordingly, a user can push the syringe guide 90 into the open position (e.g., against the stop 91) and disposed the syringe 20 into the groove 92 (e.g., slide the syringe 20 along the groove 92). The groove 92 may, at least in one characterization, be said to direct or orient the syringe 20 along a predefined path aligned with the opening 16 of the shielding device 2, such that the syringe 20 (and the hollow needle thereof) properly engages the vial 3 containing the radioactive material within the shielding device 2. Some users may find this design beneficial in that it may tend to reduce needle-stick concerns, improve efficiency, and/or reduce radiation exposure.

To facilitate insertion and withdrawal of the syringe 20 and/or to guard against undesired radiation exposure, the dispensing stand 80 may include a lock 94 (e.g., a spring biased latch) to enable the syringe guide 90 to be locked into place. For example, once the user moves the syringe guide 90 into the open position shown in FIG. 18, the syringe guide 90 can be locked into position so that a user can withdraw radiopharmaceuticals with the syringe 20 using one or both hands. Alternatively or additionally, the syringe guide 90 can be locked into the closed position shown in FIG. 17 to promote the syringe guide 90 covering and shielding the opening 16 of the shielding device 2. It should be noted that any and all appropriate locking mechanisms that can at least temporarily provide the above-described locking function are included within the scope of the present invention. As should be evident from the possible applications of the lock 94, some embodiments of the dispensing stand 80 may not include a force providing mechanism (e.g., spring 86), in which case, the position of the arm 88 may depend on the position in which the user locks the arm 88. However, it may be desirable for the syringe guide 90 to remain biased toward a closed position throughout the process, such that the syringe guide 90 automatically returns to a protective closed position upon removal of the syringe 20.

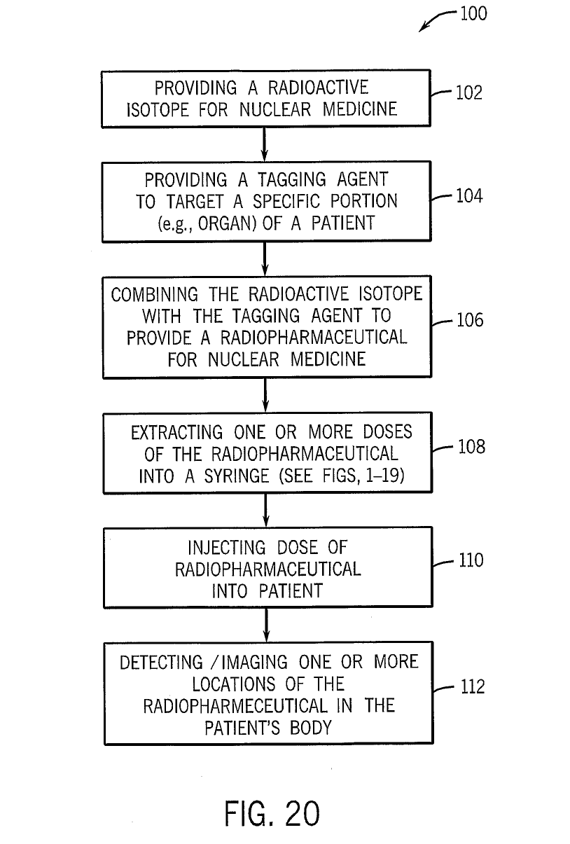

FIG. 19 illustrates a side view of the dispensing stand 80 of FIG. 18, further illustrating an additional (and optional) upper guide 96 that may interface with the syringe 20 opposite the syringe guide 90. In other words, the location of the upper guide 96 may be such that the syringe 20 is disposed between the syringe guide 90 and the upper guide 96 (e.g., when the syringe 20 is being utilized to draw radioactive fluid from the vial in the shielding device 2. In one regard, the upper guide 96 may be said to reduce a likelihood of inserting the syringe 20 into the vial in the shielding device 2 at an improper and/or undesired angle (e.g., by substantially preventing insertion of a hollow needle of the syringe 20 into the vial until the arm 88 and syringe guide 90 are moved to the open position). At a partially open position, the space between the guides 90 and 96 may be insufficient for insertion of the syringe 20. At the fully open position, the space between the guides 90 and 96 may be closely fit to the shape and dimensions of the syringe 20, thereby facilitating desired guidance of the syringe 20 (and the hollow needle thereof) straight toward the opening 16 in the shielded device 2 without tilting or shifting out of alignment. Some users may find this feature beneficial because it may reduce a likelihood of accidents associated with misaligned insertion whether the syringe guide 90 is locked into place or not.

FIG. 20 is a flowchart illustrating an exemplary nuclear medicine process utilizing a radioactive isotope provided using an elution system. As illustrated, the process 100 begins by providing a radioactive isotope for nuclear medicine at block 102. For example, block 102 may include eluting Technetium-99m from a radioisotope generator, as described in detail above. Providing the radioactive isotope (block 102) may also include withdrawing the radioactive isotope using a dispensing system in accordance with the present invention. At block 104, the process 100 proceeds by providing a tagging agent adapted to target a specific portion (e.g., particular cells or tissues) of a patient. For example, block 104 may include providing pyrophosphate, a tagging agent that highlights red blood cells. At block 106, the process 100 includes combining the radioactive isotope with the tagging agent to provide a radiopharmaceutical for nuclear medicine. Various protocols for combining a radioisotope and a tagging agent are well known in the art. The combining procedure may include utilization of a dispensing system in accordance with the present invention. It should be noted that in certain embodiments, the radioactive isotope may have natural tendencies to concentrate toward a particular organ or tissue and, thus, the radioactive isotope may be defined as a radiopharmaceutical without adding a tagging agent. At block 108, the process 100 may include extracting one or more doses of the radiopharmaceutical into a syringe or another container, such as a container suitable for administering the radiopharmaceutical to a patient in a nuclear medicine facility or hospital. This extraction procedure may include utilization of a dispensing system in accordance with the present invention. At block 110, the process 100 includes injecting or generally administering a dose of the radiopharmaceutical into a patient. After a pre-selected time, the process 100 proceeds by detecting/imaging one or more locations of the radiopharmaceutical in the patient's body. For example, block 112 may include using a gamma camera or other radioactive imaging device to detect the radioisotope disposed in a brain, a heart, a liver, a tumor, a cancerous tissue, or various other organs or diseased tissue.

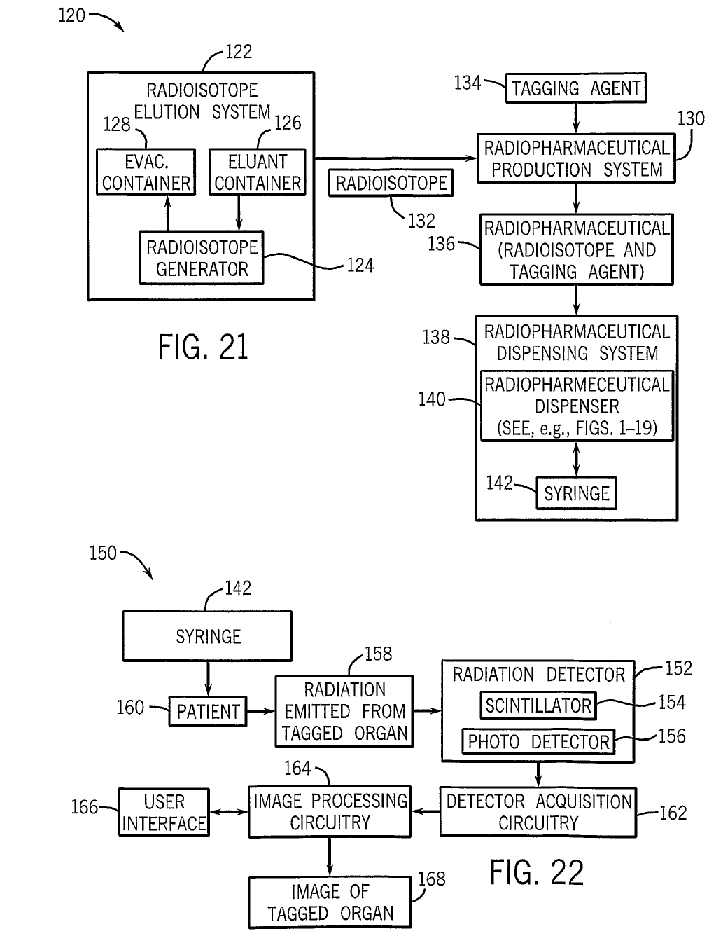

FIG. 21 is a block diagram of an exemplary system 120 for preparing a syringe of a radiopharmaceutical for use in a nuclear medicine application. As illustrated, the system 120 includes a radioisotope elution assembly 122 including a radioisotope generator 124, an elution supply container 126, and an evacuated container 128 as described above. The system 120 also includes a radiopharmaceutical production system 130, which functions to combine a radioisotope 132 (e.g., Technetium-99m, produced by the radioisotope elution tool 122) with a tagging agent 134. Again, the tagging agent may include a variety of substances that are targeted for a particular portion (e.g., organ, tissue, tumor, cancer, etc.) of the patient. As a result, the radiopharmaceutical production system 130 produces a radiopharmaceutical including the radioisotope 132 and the tagging agent 134, as indicated by block 136. The illustrated system 120 also includes a radiopharmaceutical dispensing system 138 that utilizes an appropriate radiopharmaceutical dispenser 140 (e.g., one of the dispensers of FIGS. 1-19), which facilitates extraction of the radiopharmaceutical into a vial or syringe 142. In certain embodiments, the various components and functions of the system 120 are disposed within a radiopharmacy, which prepares the syringe 142 of the radiopharmaceutical for use in a nuclear medicine application. For example, the syringe 142 may be prepared and delivered to a medical facility for use in diagnosis or treatment of a patient. While the FIG. 21 illustrates one example of system 120 for preparing a syringe of a radiopharmaceutical for use in a nuclear medicine application, it should be appreciated that dispensing systems of the invention may be utilized to assist in dispensing radioactive materials for use with any appropriate syringe-preparing system.

FIG. 22 is a block diagram of an exemplary nuclear medicine imaging system 150 utilizing the syringe 142 of radiopharmaceutical produced by the system 120 of FIG. 21. The nuclear medicine imagining system 150 includes a radiation detector 152 having a scintillator 154 and a photo detector 156. In response to radiation 158 emitted from a tagged organ within a patient 160, the scintillator 154 emits light that is sensed and converted to electronic signals by the photo detector 156. Although not illustrated, the imaging system 150 also can include a collimator to collimate the radiation 158 directed toward the radiation detector 152. The illustrated imaging system 150 also includes detector acquisition circuitry 162 and image processing circuitry 164. The detector acquisition circuitry 162 generally controls the acquisition of electronic signals from the radiation detector 152. The image processing circuitry 164 may be employed to process the electronic signals, execute examination protocols, and so forth. The illustrated imaging system 150 also includes a user interface 166 to facilitate user interaction with the image processing circuitry 164 and other components of the imaging system 150. As a result, the imaging system 150 produces an image 168 of the tagged organ within the patient 160. The foregoing procedures and resulting image 168 directly benefit from the extraction of radiopharmaceuticals using a dispensing system of the present invention. While the FIG. 22 illustrates one example of an imaging system 150, it should be appreciated that dispensing systems of the invention may be utilized to assist in dispensing radioactive materials for use with any appropriate imaging system.

While the invention may be susceptible to various modifications and alternative forms, specific embodiments have been shown by way of example in the figures and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A radiopharmaceutical system, comprising:
a radiopharmaceutical receptacle comprising a first radiation shielding material;
a cover comprising a second radiation shielding material and removably disposable across an opening into the receptacle; and
a counter-force mechanism biasingly coupled to the radiopharmaceutical receptacle or the cover or a combination thereof, the counter-force mechanism comprising a range of positionability including a closed position wherein the cover is disposed across the opening and an open position wherein the opening is uncovered.

2. The system of claim 1, wherein the counter-force mechanism comprises a reel, a line extractably wound about the reel and coupled to the radiopharmaceutical receptacle or the cover or a combination thereof.

3. The system of claim 2, further comprising a radiopharmaceutical container disposed in the radiopharmaceutical receptacle, wherein the line is coupled to the radiopharmaceutical receptacle, and wherein a selected tension in the line is less than or equal to a total weight of the radiopharmaceutical receptacle and the radiopharmaceutical container.

4. The system of claim 2, wherein the line is coupled to the radiopharmaceutical receptacle, and wherein a selected tension in the line is less than or equal to a weight of the radiopharmaceutical receptacle.

5. The system of claim 2, wherein the line is coupled to the cover, and wherein a selected tension in the line is less than or equal to a weight of the cover.

6. The system of claim 1, wherein the counter-force mechanism comprises a rotatable arm and a biasing device that effectuates torque in the rotatable arm, wherein the range of positionability includes an arcuate path relative to a rotational axis of the rotatable arm.

7. The system of claim 6, wherein the biasing device includes a spring or a weight or a combination thereof.

8. The system of claim 6, wherein the radiopharmaceutical receptacle is coupled to the rotatable arm and is movable along the arcuate path.

9. The system of claim 6, wherein the cover is coupled to the rotatable arm and is movable along the arcuate path.

10. The system of claim 9, wherein the rotatable arm comprises a syringe support that is movable along the arcuate path.

11. The system of claim 9, wherein the cover comprises a channel designed to support a syringe.

12. The system of claim 4, comprising a syringe support that is disposed adjacent the opening when the counter-force mechanism is in the open position.

13. The system of claim 1, 2 or 6, further comprising a foot pedal interconnected with the counter-force mechanism, wherein the counter-force mechanism is in the open position when the foot pedal is in a first position, and wherein the counter-force mechanism is in the closed position when the foot pedal is in a second position different from the first position.

14. The system of claim 1, comprising a locking mechanism adapted to hold the counter-force mechanism at a designated position within the range of positionability.

15. A radiopharmaceutical dispenser, comprising:
a radiopharmaceutical receptacle comprising a first radiation shielding material and configured to receive a radiopharmaceutical;
a cover comprising a second radiation shielding material and removably disposable across an opening into the receptacle;
a biasing mechanism imposing a biasing force on the radiopharmaceutical receptacle or the cover or a combination thereof; and
a movable member comprising a first portion coupled to the biasing mechanism and a second portion coupled to the radiopharmaceutical receptacle or the cover or a combination thereof, wherein a distance between the radiopharmaceutical receptacle and the cover is a first distance when the movable member is in a first position, and wherein the distance between the radiopharmaceutical receptacle and the radiopharmaceutical cover is a second distance greater than the first distance when the movable member is in a second position different from the first position.

16. The radiopharmaceutical dispenser of claim 15, wherein the movable member comprises a retractable line coupled to the radiopharmaceutical receptacle.

17. The radiopharmaceutical dispenser of claim 15, further comprising a sheath having a connection ring, wherein the sheath is disposed about at least a portion of the radiopharmaceutical receptacle.

18. The radiopharmaceutical dispenser of claim 15, wherein the movable member comprises a rotatable arm having a pivot joint, wherein the first portion is offset by a first distance relative to the pivot joint, and the second portion is offset by a second distance relative to the pivot joint.

19. The radiopharmaceutical dispenser of claim 18, wherein the cover is stationary and the radiopharmaceutical receptacle is movable with the rotatable arm.

20. The radiopharmaceutical dispenser of claim 18, wherein the radiopharmaceutical receptacle is stationary and the cover is movable with the rotatable arm.

21. The radiopharmaceutical dispenser of claim 20, comprising a syringe support disposed adjacent the cover, wherein the syringe support is movable with the rotatable arm.

22. The radiopharmaceutical dispenser of claim 15, wherein the movable member comprises a rotatable arm pivotally interconnected with the cover or the receptacle or a combination thereof.

23. The radiopharmaceutical dispenser of claim 15, comprising a locking mechanism adapted to counter the biasing mechanism and hold either the radiopharmaceutical receptacle or the cover in the first position, the second position, or a position between the first and second positions.

24. The radiopharmaceutical dispenser of claim 15, comprising a vial of the radiopharmaceutical is disposed within the radiopharmaceutical receptacle.

25. A method of using a radiopharmaceutical dispenser, comprising:
imposing a first force in a first direction on a first component of a radiopharmaceutical dispenser, the first component comprising a radiation shielding material; and
supplementing the first force with a second force having a vector component substantially aligned with the first direction, wherein the imposition of the first force is insufficient to move the first component relative to a second component of the radiopharmaceutical dispenser, and wherein the supplementation of the second force is sufficient to move the first component relative to the second component, wherein the second component comprises a radiation shielding material, and wherein the first and second components cooperate to contain a radiopharmaceutical.

26. The method of claim 25, wherein the first direction is substantially arcuate.

27. The method of claim 25, wherein the first direction is substantially linear.

28. The method of claim 25, wherein the supplementing comprises exposing a portion of a radiopharmaceutical container from which contents of the container may be accessed using a needle of a syringe.

29. A method, comprising:
supporting a radiopharmaceutical container on a base, wherein the radiopharmaceutical container comprises a first radiation shielding material;
movably supporting a radiopharmaceutical cover along a path of travel between a first position at which the radiopharmaceutical cover extends across an opening in the radiopharmaceutical container and a second position at which the radiopharmaceutical cover is offset from the opening of the radiopharmaceutical container, wherein the radiopharmaceutical cover comprises a second radiation shielding material; and
biasing the radiopharmaceutical cover toward the first position.

30. The method of claim 29, wherein biasing comprises leveraging the radiopharmaceutical container cover against a counter-force device about a pivot point, wherein the path of travel is substantially arcuate about the pivot point.

31. The method of claim 29, comprising supporting a syringe adjacent the radiopharmaceutical cover on a rotatable structure at the second position at which the radiopharmaceutical cover is offset from the opening of the radiopharmaceutical container.

32. The method of claim 31, wherein supporting the syringe comprises aligning the syringe with the opening for a substantially centered connection between the syringe and the opening.
